(19) United States
(12) Patent Application Publication
(10) Pub. No.: US 2013/0100836 A1
(43) Pub. Date: Apr. 25, 2013

(54) Allocating One or More Resources (e.g. carriers) to a Network Element (e.g. HeNB) in a Communication System

(71) Applicants: Agnieszka Szufarska, Gdansk (PL); Klaus Ingemann Pedersen, Aalborg (DK)

(72) Inventors: Agnieszka Szufarska, Gdansk (PL); Klaus Ingemann Pedersen, Aalborg (DK)

(73) Assignee: Nokia Siemens Networks Oy, Espoo (FI)

(21) Appl. No.: 13/638,726

(22) PCT Filed: Mar. 30, 2010
(86) PCT No.: PCT/EP2010/054213

§ 371 Date: Jan. 3, 2013

(51) Int. Cl. H04W 72/08

(52) U.S. Cl. CPC H04W 72/085
USPC 370/252

(57) ABSTRACT

A method of allocating one or more carriers such as frequencies, to a network element (e.g. HeNBs) in a communication system, in particular a heterogeneous communication system including selecting at least one neighbouring network element (e.g. a macro base station), measuring a parameter (e.g. RSRP) from the one neighbouring network element; determining whether said parameter is above a threshold; and allocating carrier(s) to said network element as a result.

This disclosure relates to the operation of communications networks, and has particular, but not exclusive, application to heterogeneous networks. Such networks, as will be described in more detail later, generally comprise two different overlayed networks, where typically the base stations (or nodes) used for each of the different networks are of a different type. Thus the disclosure relates in particular, but not exclusively, to the operation of heterogeneous networks with a mixture of node types, such as eNodeBs (macro base stations) and Home Node Bs (HeNBs).

Furthermore the disclosure, in particular but not exclusively, relates to management of interference between the overlayed systems and the allocation of carriers/frequencies to nodes of the networks.

Embodiments have particular but non exclusive application to Long Term Evolved Advanced networks (LTE-Advanced), where the use of carrier aggregation is supported.

A communication system can be seen as a facility that enables communication sessions between two or more entities. The communications may comprise, for example, communication of voice, electronic mail (email), text message, multimedia, other data and so on. A communication system can be provided for example by means of a communication network and one or more compatible communication devices. The communication network may be a local network.

A user can access a communication system by means of an appropriate communication device. A communication device of a user is often referred to as user equipment (UE). A communication device is provided with an appropriate signal receiving and transmitting apparatus for enabling communications, for example enabling fixed or wireless access to a communication network or communications directly with other users. Users may thus be offered and provided numerous services via their communication devices. Non-limiting examples of these services include two-way or multi-way calls, data communication or multimedia services or simply an access to a data communications network system, such as the Internet. A user who has accessed a system may also be provided broadcast or multicast content. Non-limiting examples of the content include downloads, television and radio programs, videos, advertisements, various alerts and other information.

Communication networks typically comprise a plurality of base stations, (alternatively referred generally as Node Bs), with which a UE can communicate with when located within in a cell for which a base station has coverage. Such base stations are typically and conventionally under the control of a network controller. Such base station are often referred to as “macro” base stations when distinguishing them from base stations (nodes) of other types of networks, such as Home Networks.

Alternatively, networks may be provided which have may not have central control (autonomous networks). These include Self Optimising Networks (SON), the advantages of which reduce the operating expenditure associated with the management of large number of (macro) base stations (eNBs). Also Home Networks (or Local Area Networks) are known which usually operate in a limited area and often for a Closed Subscriber Group (CSG). These may be used to provided coverage for a particular group of UEs within, for example, a building or relatively small local area. Base stations or network nodes for such systems are referred to as Home Node B (HeNB), Femto nodes, Pico nodes etc.

Often two different types of network may exist in an area, and the networks may be overlayed to provide a “heterogeneous” network. For example the use of a SON with a cellular network under central control is a useful method of increasing system capacity.

Thus a heterogeneous system may comprise a mixture of macro base stations/cells and HeNBs. Deployment of such systems is an efficient way of increasing system capacity.

However, the use of such overlayed/heterogeneous systems (which may provide a service to the same or different user equipment) presents certain problems; in particular with interference and assigning carrier (frequency) resources. For example, there may be a cellular system under central control, wherein the (macro) base stations use two carriers, denoted by f1 and f2. A problem of allocating these frequencies to nodes (e.g. HeNBs) of an overlapped home network is that either or both these frequencies may interfere with operation of macro base stations, as will be described in more detail.

In prior art solutions, for example, only one of the two carriers f1 or f2 is allocated to each HeNB, based on direction estimation, leaving one carrier of the macro base station free of HeNB interference in the close vicinity of each HeNB, where macro-UEs can be served without problems. However, using such solutions naturally limits the performance of nodes of the other network (e.g. HeNB) to what is possible within the bandwidth of one carrier. It is not possible for the certain nodes (e.g. HeNBs) to operate on all frequency resources.

In certain embodiments is provided an improved carrier selection scheme, which also allow nodes of both (sub-) networks to use a plurality of shared carriers (e.g. frequencies) under certain conditions, and so as not to degrade the macro-UE coverage.

In an first embodiment is provided a method of allocating one or more resources to a network element in a communication system, comprising: selecting at least one neighbouring network element; measuring a parameter indicative of the strength, power and/or /quality of a signal from said at least one neighbouring network element; determining whether said parameter is above a threshold; and, allocating resources to said network element as a result of said determining.

In a second embodiment is provided apparatus having means to allocate one or more resources to a network element in a communication system, comprising: means to select at least one neighbouring network element; means to measure a parameter indicative of strength, power and/or quality of a signal from said at least one neighbouring network element; means to determine whether said parameter is above a threshold; and, means to allocate resources to said network element as a result of said determining.

In a third embodiment is provided an apparatus adapted to allocate one or more resources to a network element in a communication system, which is adapted to: select at least one neighbouring network element; measure a parameter indicative of strength, power and/or quality of a signal from said at least one neighbouring network element; determine whether said parameter is above a threshold; and, allocate resources to said network element as a result of said determining.

The resources may be carriers, and wherein if one or more said parameters is above said threshold, embodiment as may allocate a first number of carriers to said network element, and if said parameter is not above said threshold, allocating a second, lesser number of carriers.

The second number may be one less than said first number.

The network element and/or said neighbouring network element may be a base station, macro base station, Home Node B, Femto Node B, Pico Node B, relay node, or “plug and play” node.

The network element and said neighbouring network elements may be network elements of different systems or network elements of two or more (sub)-systems of a heterogeneous network.

The network element and said neighbouring network element(s) may be different type of nodes.

The network element may be a Home Node B, Femto Node B, Pico Node B, relay node, or “plug and play” node. The neighbouring element(s) may be a macro base station or relay node.

The network element may be part of a home network or closed subscriber group network, and/or said neighbouring network element may be a macro base station, relay therefor, or part of an open subscriber group network.

The carriers may be frequencies.

Selecting at least one neighbouring network element may comprise (means for) selecting that neighbouring network element which can properly be decoded and whose signal strength is the highest.

Selecting at least one neighbouring network element may comprise (means for) selecting that network element which can properly be decoded and whose signal strength is the lowest.

The method/apparatus may include an initial step/means of measuring a parameter of signal strength from one or more neighbouring base stations.

A plurality of neighbouring network elements may be selected, and the determining step may determine whether each parameter is above a threshold corresponding to the neighbouring network element.

The means/steps of selecting, measuring and determining may be repeated for one or more further neighbouring network element, and said allocating step may be dependent on the result of said determining for more than one neighbouring base station.

The parameter may be Received Signal Reference Power.

In a fourth embodiment is provided a computer program comprising program code means adapted to perform the steps of any of the methods when the program is run on a processor, and to a computer readable medium comprising such computer programs.

For a better understanding of the present invention and how the same may be carried into effect, reference will now be made by way of example only, and to the accompanying drawings in which:

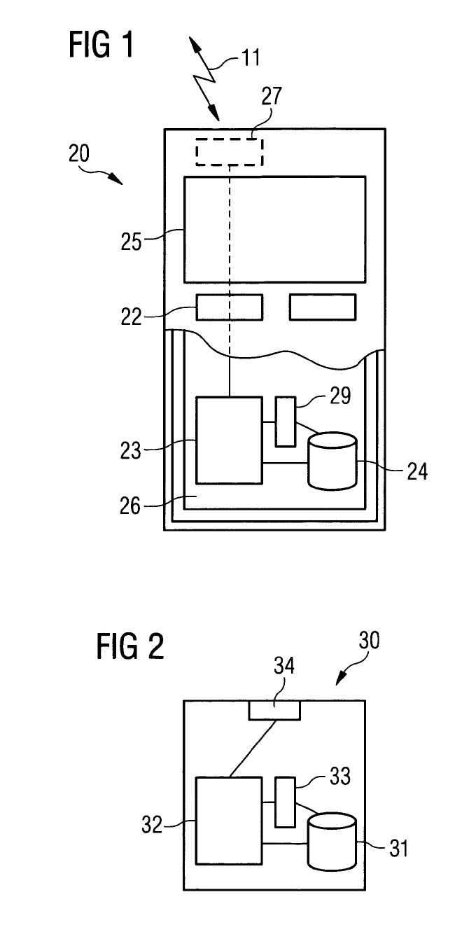

FIG. 1 shows a schematic representation of a communication device such as a user equipment;

FIG. 2 shows an example of a controller for a network element such as a base station/node;

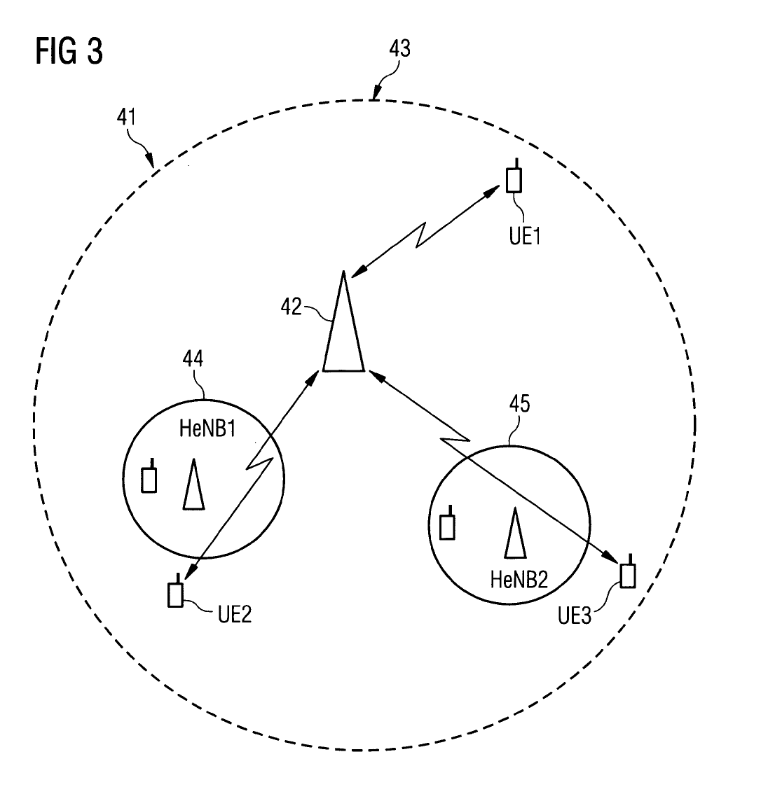

FIG. 3 shows a schematic representation of heterogeneous/overlayed networks and problems associated therewith; and

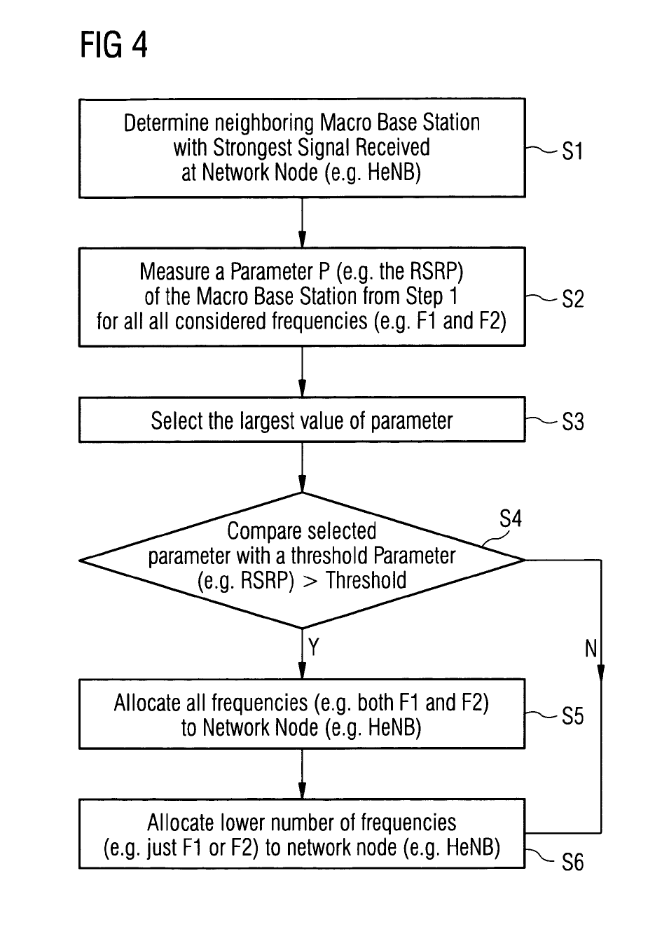

FIG. 4 shows a flow diagram illustrating one embodiment.

In the following certain exemplifying embodiments are explained with reference to wireless or mobile communication systems serving mobile communication devices. Before explaining in detail the certain exemplifying embodiments, certain general principles of a wireless communication system and mobile communication devices are briefly explained with reference to FIGS. 1 and 2 to assist in understanding the technology underlying the described examples.

A communication device can be used for accessing various services and/or applications provided via a communication system. A typical communication system may comprise a number of cells, each associated with particular fixed base stations. Non-limiting examples of appropriate access nodes are a base station of a cellular system, for example what is known as NodeB or enhanced NodeB (eNB) in the vocabulary of the 3GPP specifications. Other examples include base stations of systems that are based on technologies such as wireless local area network (WLAN) and/or WiMax (Worldwide Interoperability for Microwave Access). The base stations may be in communication with a Network Controller (not shown). A UE may be located at a particular location within a particular cell. Each cell (and/or base station) has associated with it a general topological/geographical location, shown generally as encompassed by the broken lines in the figure. Base stations under central control i.e. part of a conventional cellular system are often referred to as “macro base stations”. The base stations may be connected to a wider communications network (not shown). A gateway function may also be provided to connect to another network. This further network may also be connected to a further access system, which serves user devices.

In addition, other types of networks such as Self Optimised Networks, Local or Home Networks may exist, where they may be no central control. These may also be Closed Subscriber Group networks. Base stations (nodes) in such systems are often referred to as Home Node Bs (HeNB), Femto Nodes, Pico Nodes. Generally such nodes operates at lower power than macro base stations. Further more in all types of networks, relays nodes may be present which operate in a similar fashion and act like base stations. Embodiments are also applicable to (the control of) and/or the treatment of any such nodes as macro base stations.

A communication device can be used for accessing various services and/or applications through the communication system. A mobile communication device is typically provided wireless access via at least one base station or similar wireless transmitter and/or receiver node of the access system. A base station site can provide one or more cells of the plurality of cells of a cellular communication system. The communication devices can access the communication system based on various access techniques, such as code division multiple access (CDMA), or wideband CDMA (WCDMA). The latter technique is used by communication systems based on the third Generation Partnership Project (3GPP) specifications. Other examples include time division multiple access (TDMA), frequency division multiple access (FDMA), space division multiple access (SDMA) and so on. An example of the more recent developments in the standardization is the long-term evolution (LTE) of the Universal Mobile Telecommunications System (UMTS) radio-access technology that is being standardized by the 3rd Generation Partnership Project (3GPP). A further development of the LTE is referred to as LTE-Advanced. Other techniques may be used such as orthogonal frequency divisional multiple access (OFDMA) and SC-FDMA, e.g. for downlink and uplink operation respectively.

FIG. 1 shows a schematic, partially sectioned view of a communication device 20 that can be used for communication with a communication system. An appropriate mobile communication device may be provided by any device capable of sending and receiving radio signals. Non-limiting examples include a UE, a portable computer provided with a wireless interface card or other wireless interface facility, personal data assistant (PDA) provided with wireless communication capabilities, or any combinations of these or the like. A mobile communication device may be used for voice and video calls, for accessing service applications and so on. The mobile device may receive signals over an air interface 11 via appropriate apparatus for receiving and may transmit signals via appropriate apparatus for transmitting radio signals. A transceiver is designated schematically by block 27. The transceiver may be provided for example by means of a radio part and associated antenna arrangement. The antenna arrangement may be arranged internally or externally to the mobile device.

A mobile device is also typically provided with at least one data processing entity 23, at least one memory 24 and other possible components 29 for use in software aided execution of tasks it is designed to perform, including control of access to and communications with access systems. The data processing, storage and other relevant control apparatus can be provided on an appropriate circuit board and/or in chipsets. This feature is denoted by reference 26. The controller may include functionality to carry out any embodiments of the invention. The user may control the operation of the mobile device by means of a suitable user interface such as key pad 22, voice commands, touch sensitive screen or pad, combinations thereof or the like. A display 25, a speaker and a microphone are also typically provided. Furthermore, a mobile communication device may comprise appropriate connectors (either wired or wireless) to other devices and/or for connecting external accessories, for example hands-free equipment, thereto.

FIG. 2 shows an example of a control apparatus 30 for a base station. The control apparatus 30 can be arranged to provide control on communications by roaming mobile communication devices according to embodiments of the invention. The control apparatus 30 may be configured to implement any of the embodiments of the invention. The control apparatus 30 can be configured to execute an appropriate software code to provide the control functions as explained below in more detail. For this purpose the control apparatus comprises at least one memory 31, at least one data processing unit 32, 33 and an input/output interface 34. Via the interface the control apparatus can be coupled to a receiver and a transmitter of the system, for example a base station antenna, so that it can receive/transmit a transmission from/to the communication device. Control on communications by the communication device can then be based on this determination.

As mentioned Home Networks using HeNBs/Local Area nodes/femto nodes (HNB, HeNB) are playing an increasingly important part in that provide (further) coverage/capacity especially indoors. Especially as these may be configured to operate as Closed Subscriber Groups, this provides a challenge for enabling efficient operation of different overlayed/underlay network (layers)/use in heterogeneous systems.

FIG. 3 shows a schematic representation illustrating potential interference of a heterogeneous communication network 41. The heterogeneous network includes a conventional Node B, 42 (a Macro eNB) of a cellular system (e.g. under central control) which provide coverage to UEs within the coverage of cell 43 (designated by the dotted line). Within the cell area are be located one or more cells 44 and 45 of home networks providing additional overlayed systems/capacity. Each of these cells 44 and 45 are provided by Home Network nodes HeNB1 and HeNB2 respectively. They may be part of a home network, SON, or autonomous network, e.g. may be Pico/Femto/relay nodes.

As can be seen, there arises the problem of interference when the same carriers (e.g. frequencies) are used in the two (or more systems). In the case of UE2 and UE3, communication between the macro base station is via areas of the cells of home networks 44 and 45. If the macro base station (macro eNB) operates on two carriers (e.g. f1 and f2). In prior art solutions, HeNBs would assume the macro base station to use both carriers and only use one of the carriers (f1 or f2) for its own operation.

The inventors have determined that if for example one or more signals from e.g. a macro base station are sufficiently strong, (e.g. the Received Signal Reference Power (RSRP) is high enough), then a UE in close vicinity of a home base station will be able to decode the control and data channels from the macro eNB even if the HeNB uses both f1 and f2.

Thus, according to one embodiment, it allows HeNBs close to macro eNBs to use both f1 and f2. HeNBs further away from the macro-eNB may only use one carrier, always leaving a carrier free of HeNB interference for the macrocell-edge-users to be served on.

### EXAMPLE 1

In one embodiment the following procedure is performed. The example refers to a heterogeneous system, comprising a network of macro base stations and one or more networks provided by home base stations (HeNBs). However the embodiments can be applied to any heterogeneous systems or in any situation where there are different types of base stations/nodes. Two frequencies f1 and f2 are considered here for simplicity but any number of frequencies/carriers may be considered.

Firstly, each HeNB measures a parameter indicative of signal strength (such as the RSRP) from the “strongest” macro base station. The term “strongest” denotes that macro base station which can be decoded by the HeNB, and which has the highest signal strength. This may be for example the highest RSRP.

RSRP may be measured on all considered frequencies. For example where there are two frequencies used, f1 and f2, strengths in relation to the two frequencies are measured. The largest RSRP value is then selected.

If the selected RSRP is greater than a threshold, then the HeNB is allocated and uses both frequencies f1 and f2 for communication (i.e. with UEs).

Alternatively if the selected RSRP is less than (or equal to) the threshold, the HeNB is only allocated one of the carriers (i.e. f1 or f2). The selection of which carrier can be made according to known techniques as in the prior art.

This allows e.g. HeNBs to use both f1 and f2 under certain circumstances (e.g. where there is sufficient power from the neighbouring (e.g. macro base station) for it not be a problem. This allows higher peak data rates for users as compared to HeNBs using only one carrier, especially in LTE-Advanced systems with carrier aggregation.

In some embodiments, (e.g. in particular where there are other, open access low power nodes present in the system) an alternative parameter may be measured rather than the RSRP. The parameter may be indicative or related to the l strength, power and/or quality of a signal from the other selected cell.

In additions, the appropriate parameter (e.g. RSRP) may be compared alternatively for carriers/frequencies of the “weakest” base station/cell (that can be properly decoded by a HeNB); or indeed, from any neighbouring base station/node.

The skilled person would readily be aware of various methods of determining a suitable threshold. The threshold parameter may for example be decided (i.e. based on) simple link budget exercise or it can be slow adjusted based on e.g. a SON mechanism. The threshold may alternatively be configured semi-statistically.

In certain embodiments, there may be an initial step of determining which macro base station provides the “strongest” or the “weakest” signals. Thus there may be an initial measuring step. Alternatively, this initial step may not be required. For example, both the HeNBs and macro NBs may be fixed in location, the closest macro base station may be assumed to be the macro base station which provides the strongest signal; thus the macro base station (for which the carriers are compared with a parameter) may be predetermined, known or assumed.

In certain embodiments, the measurement step only is needed during the initialization of the HeNB.

Although the embodiment above describes the case with two carriers (frequencies) the case, embodiments may cover cases with more carriers. As far as allocation of carriers is concerned in such cases, depending on the comparison with thresholds, the node may be allocated more or less carriers. If there are 8 carriers for example, and the measured parameter is less than the threshold, then 7 carriers may be allocated, or 6, or 5 etc.

Furthermore, a plurality of neighbouring network elements (e.g. macro base stations) may be selected, and for each, the parameter (such as RSPS) for each carrier determined and compared with the same threshold, or a specific threshold according to the particular neighbouring base station.

Embodiments may be implemented in heterogeneous scenarios and/or where there are more than two types of nodes, e.g. Open Subscriber Group macro nodes and Closed Subscriber Group (femto) nodes.

There may be also further types of open access nodes (e.g. Pico nodes) present. In some embodiments, parameters of carrier(s) (such as RSRP) may be evaluated (by e.g. an HeNB) from any neighbouring/open access node or from any node which isn't of the same type of isn't part of the same (sub-) system.

FIG. 4 shows a flow chart illustrating one embodiment of the invention which provide for allocating carriers (e.g. frequencies), to a network element (network node) such as an HeNB.
In step S1, the strongest neighbouring macro base station, i.e. that base station whose signal can be properly decoded by the network node and whose signal strength is the strongest, is selected.
In step S2, an appropriate parameter such as the RSRP of the selected base station is determined/measured for all carriers e.g. for all considered frequencies (e.g. f1 and f2).
In step S3, the largest value of the parameters from step S2 is selected.
At step S4, the value from step S4 is compared with a threshold.
At step S5, if the parameter is greater than the threshold, then all carriers (e.g. frequencies) e.g. both f1 and f2 are allocated to the network Node (HeNB).
If not, then at step S6, a lower number of frequencies is allocated to the access node (e.g. just either f1 or f2).

As mentioned steps S2, S3 and S4 may be repeated for more than one base neighbouring base station. The allocation of frequencies may be dependent on all the comparison steps.

One advantage of the embodiments is improved network performance by allowing more efficient and dynamic frequency assignment for nodes (such as HeNBs). Embodiments may use different parameter settings (e.g. RSRP threshold) to allow nodes (such as HeNB) in certain circumstances to use two or more component carriers allowing heterogeneous networks to be used in a more efficient manner at the same time taking into consideration risks of interference.

Embodiments enable more efficient utilization of frequency resources and at the same time minimizes effort to configure the nodes manually by users or technicians through the inventions auto-configuration feature

Embodiments also advantageously can be implemented in LTE Rel-8 without need for additional standardization.

The above described functions can be provided by means of appropriate software and data processing apparatus. Functions may be incorporated into any appropriate network element or management system and may be provided by means of one or more data processors. The data processor may be provided by means of, for example, at least one chip. Appropriate data processing may be provided in a processing unit provided in association with a communication device, for example a mobile station. The data processing may be distributed across several data processing modules. The above described functions may be provided by separate processors or by an integrated processor. An appropriately adapted computer program code product or products may be used for implementing the embodiments, when loaded on an appropriate data processing apparatus. The program code product for providing the operation may be stored on and provided by means of an appropriate carrier medium. An appropriate computer program can be embodied on a computer readable record medium. A possibility is to download the program code product to a communication device via a data network.

It is also noted that although certain embodiments were described above by way of example with reference to certain exemplifying architectures for wireless networks, technologies and standards, embodiments may be applied to any other suitable forms of communication systems than those illustrated and described herein.

It is also noted herein that while the above describes exemplifying embodiments of the invention, there are several variations and modifications which may be made to the disclosed solution without departing from the scope of the present invention.

1. A method of allocating one or more resources to a network element in a communication system, comprising: selecting at least one neighbouring network element; measuring a parameter indicative of the strength, power and/or quality of a signal from said at least one neighbouring network element;
determining whether said parameter is above a threshold; and,
allocating resources to said network element as a result of said determining.

2. A method as claimed in claim 1 wherein said resources are carriers, and wherein if one or more said parameters is above said threshold, allocating a first number of carriers to said network element, and if said parameter is not above said threshold, allocating a second, lesser number of carriers.

3. A method as claimed in claim 2 wherein said second number is one less than said first number.

4. A method as claimed in claim 1 wherein said network element and/or said neighbouring network element is a base station, macro base station, Home Node B, Femto Node B, Pico Node B, relay node, or “plug and play” node.

5. A method as claimed in claim 1 wherein said network element and said neighbouring network elements are network elements of different systems or network elements of two or more (sub)-systems of a heterogeneous network.

6. A method as claimed in claim 1 wherein said network element and said neighbouring network element (s) are different type of nodes.

7. A method as claimed in claim 1 wherein said network element is a Home Node B, Femto Node B, Pico Node B, relay node, or “plug and play” node.

8. A method as claimed in claim 1 wherein said neighbouring element (s) is a macro base station or relay node.

9. A method as claimed in claim 5 wherein said network element is part of a home network or closed subscriber group network, and/or said neighbouring network element is macro base station, relay therefor, or part of an open subscriber group network.

10. A method as claimed in claim 1 wherein said carriers are frequencies.

11. A method as claimed in claim 1 wherein said selecting at least one neighbouring network element comprises selecting that neighbouring network element which can properly be decoded and whose signal strength is the highest.

12. A method as claimed in claim 1 wherein said selecting at least one neighbouring network element comprises selecting that network element which can properly be decoded and whose signal strength is the lowest.

13. A method as claimed in claim 1 including an initial step of measuring a parameter of signal strength from one or more neighbouring base stations.

14. A method as claimed in claim 1 wherein a plurality of neighbouring network elements are selected, and wherein the determining step determines whether each parameter is above a threshold corresponding to the neighbouring network element.

15. A method as claimed in claim 1 wherein the steps of selecting, measuring and determining are repeated for one or more further neighbouring network element, and said allocating step is dependent on the re-suit of said determining for more than one neighbouring base station.

16. A method as claimed in claim 1 wherein said parameter is Received Signal Reference Power.

17. A computer program comprising program code means adapted to perform the steps of claim 1 when the program is run on a processor.

18. A computer readable medium comprising a computer program of claim 17.

19. An apparatus having means to allocate one or more resources to a network element in a communication system, comprising:
means to select at least one neighbouring network element;
means to measure a parameter indicative of strength, power and/or quality of a signal from said at least one neighbouring network element;
means to determine whether said parameter is above a threshold; and,
means to allocate resources to said network element as a result of said determining.

20. An apparatus as claimed in claim 19 wherein said resources are carriers, and wherein if one or more said parameter is above said threshold, the means for allocating comprises means to allocate a first number of carriers to said network element, and if said parameter is not above said threshold, allocating a second, lesser number of carriers.

21. An apparatus as claimed in claim 20 wherein said second number is one less than said first number.

22. An apparatus as claimed in claim 19 wherein said network element and/or said neighbouring network element is a base station, macro base station, Home Node B, Femto Node B, Pico Node B, relay node, or “plug and play” node.

23. An apparatus as claimed in claim 19 wherein said network element and said neighbouring network elements are network elements of different systems or network elements of two or more (sub)-systems of a heterogeneous network.

24. An apparatus as claimed in claim 19 wherein said network element and said neighbouring network element (s) are different type of nodes.

25. An apparatus as claimed in claim 19 wherein said network element is a Home Node B, Femto Node B, Pico Node B, relay node, or “plug and play” node.

26. An apparatus as claimed in claim 19 wherein said neighbouring element (s) is a macro base station or relay node.

27. An apparatus as claimed in claim 19 wherein said network element is part of a home network or closed subscriber group network, and/or said neighbouring network element is macro base station, relay therefor, or part of an open subscriber group network.

28. An apparatus as claimed in claim 19 wherein said carriers are frequencies.

29. An apparatus as claimed in claim 19 wherein said means to select at least one neighbouring network element comprises means to select that neighbouring network element which can properly be decoded and whose signal strength is the highest.

30. An apparatus as claimed in claim 19 wherein said means to select at least one neighbouring network element comprises means to select that network element which can properly be decoded and whose signal strength is the lowest.

31. An apparatus as claimed in claim 19 including an initial step of measuring a parameter of signal strength from one or more neighbouring base stations.

32. An apparatus as claimed in claim 19 wherein a plurality of neighbouring network elements are selected, and wherein the determining step determines whether each parameter is above a threshold corresponding to the neighbouring network element.

33. An apparatus as claimed in claim 19 having means to repeat selecting, measuring and determining for one or more further neighbouring network element, and having allocation means dependent on the result of said determining for more than one neighbouring base station.

34. An apparatus as claimed in claim 19 wherein said parameter is Received Signal Reference Power.

35. An apparatus adapted to allocate one or more resources to a network element in a communication system, which is adapted to:
select at least one neighbouring network element;
measure a parameter indicative of strength, power and/or quality of a signal from said at least one neighbouring network element;
determine whether said parameter is above a threshold; and,
allocate resources to said network element as a result of said determining.

36. An apparatus as claimed in claim 35 wherein said resources are carriers, and further adapted to determine if one or more said parameter is above said threshold, and allocate a first number of carriers to said network element, and if said parameter is not above said threshold, allocating a second, lesser number of carriers.

37. An apparatus as claimed in claim 36 wherein said second number is one less than said first number.

38. An apparatus as claimed in claim 35 wherein said network element and/or said neighbouring network element is a base station, macro base station, Home Node B, Femto Node B, Pico Node B, relay node, or “plug and play” node.

39. An apparatus as claimed in claim 35 wherein said network element and said neighbouring network elements are network elements of different systems or network elements of two or more (sub)-systems of a heterogeneous network.

40. An apparatus as claimed in claim 35 wherein said network element and said neighbouring network element (s) are different type of nodes.

41. A apparatus as claimed in claim 35 wherein said network element is a Home Node B, Femto Node B, Pico Node B, relay node, or “plug and play” node.

42. An apparatus as claimed in claim 35 wherein said neighbouring element (s) is a macro base station or relay node.

43. An apparatus as claimed in claim 35 wherein said network element is part of a home network or closed subscriber group network, and/or said neighbouring network element is macro base station, relay therefor, or part of an open subscriber group network.

44. An apparatus as claimed in claim 35 wherein said carriers are frequencies.

45. An apparatus as claimed in claim 35 adapted to select that neighbouring network element which can properly be decoded and whose signal strength is the highest.

46. An apparatus as claimed in claim 35 adapted to select that network element which can properly be decoded and whose signal strength is the lowest.

47. An apparatus as claimed in claim 35 adapted to measure a parameter of signal strength from one or more neighbouring base stations.

48. An apparatus as claimed in claim 35 adapted to select a plurality of neighbouring network elements, and determine whether each parameter is above a threshold corresponding to the neighbouring network element.

49. An apparatus as claimed in claim 35 adapted to repeat the selecting, measuring and determining for one or more further neighbouring network element, and to allocate dependent on the result of said determining for more than one neighbouring base station.

50. An apparatus as claimed in claim 35 wherein said parameter is Received Signal Reference Power.

51. An apparatus as claimed in claim 19 which is a controller, processor and/or part of said network element.
